(19) United States
(12) Patent Application Publication
(10) Pub. No.: US 2009/0205578 A1
(43) Pub. Date: Aug. 20, 2009

(54) Wheeled Pet Carrier with Detachable Litter Box

(76) Inventor: Stephanie Gail Alves, Venice, CA (US)

Correspondence Address: IP Authority, LLC;Ramraj Soundararajan, 4821A Eisenhower Ave, Alexandria, VA, 22304, US

(21) Appl. No.: 12/031,364

(22) Filed: Feb. 14, 2008

(51) Int. Cl. A01K 31/07; A01K 1/03

(52) U.S. Cl. 119/454; 119/453; 119/496; 119/497

(57) ABSTRACT

Disclosed is a wheeled pet carrier that also contains a detachable litter box, wherein the pet carrier also optionally has a retractable shoulder strap and a retractable handle. The retractable handle can be used to pull the wheeled pet carrier. The litter box portion also optionally has a deodorizer.

### BACKGROUND OF THE INVENTION

1. Field of Invention

The present invention relates generally to the field of pet carriers. More specifically, the present invention is related to a wheeled pet carrier with a detachable litter box.

2. Discussion of Prior Art

The following references generally outline a pet carrier but none teach a wheeled pet carrier with a detachable litter box as per the teachings of the present invention.

The patent to Ingebritsen (U.S. Pat. No. 3,487,814) provides for a Portable Ventilated Pet Station. FIG. 1 illustrates a portable pet station 10 with two removably attachable panels, entrance panel 11 and cleaning panel 12. As shown, the pet station may hold litter box 30. The pet station is carried by handle 19.

The patent to Simons et al. (U.S. Pat. No. 5,092,270) provides for a Carrier Cage for Cats or Other Small Animals. FIGS. 1 and 6 illustrate box carrier 8 with base structure 12 and carrying handle 14. Base structure 12 has floor 21 for compartment 10, which is covered with padding 22. Floor 23 provides recess 24 for a removable litter box 25 that may be slidable in and out of base structure 12 as a drawer. Hinged door 33 is provided as a cover and as access to litter box 25.

The patent to White (U.S. Pat. No. 5,471,950) provides for an Animal Carrier with Detachable Litter Box. Animal litter container 20 may be attached to carrier 22 by a latch. Openings 30 and 34 are provided to allow the passage of a cat or other animal between the carrier and the litter box.

The patent to Satcher et al. (U.S. Pat. No. 5,503,107) provides for a Pet Carrier. Disclosed is a pet carrier having a closable litter box and closable water and food containers. Opening 9 is provided in compartment 1 for inserting a pet. Litter box 11, with pet litter 18, is accessed by panel 12. Also shown are food container 21 and water container 23. Handle 47 is detachably connected to handle connectors 46 at the top of compartment 1.

The following references describe pet carriers having removable trays and other features, but do not appear to specifically mention a detachable litter box:

The patent to Farrugia (U.S. Pat. No. 5,671,698) provides for a Pet Carrier. Described is pet carrier 1 with bottom panel 2 and door 12. FIGS. 5 and 6 show rectangular tray 24 which may be placed in the bottom of pet carrier 1. Absorbent pad 25 may be placed in tray 24 for hygiene purposes. Bottom panel 2 also has four supporting legs 19. Coupling rings 21 may also be attached to the top of carrier 1 to attach a shoulder strap 22.

The patent to Dillon (U.S. Pat. No. 5,678,509) provides for an All-In-One Litter Box, Sleeping Area, and Food and Water Bowl System Useable as a Pet Carrier. The disclosed system 10 comprises a plurality of components, such as box 12, slidable door 36, carpet 42, rectangular tray 52, and food and water bowls 72 and 70, that all may be used in pet carrier 10 for cats.

The patent to Martz (U.S. Pat. No. 6,021,740), assigned to Gayle Martz, Inc., provides for a Wheeled Animal Carrier. Portable animal carrier 10 includes bottom wall 12 and end walls 16, 18. Strap 36 may function as a datable shoulder strap. Carrier also includes a plurality of wheels 70 on the corners of bottom panel 12, cushioned sound absorbing liner 82, and removable tray 84.

The patent to Godshaw (U.S. Pat. No. 6,155,206), assigned to Travel Caddy, Inc., provides for an Animal Travel Bag. FIGS. 1, 4, and 5 show a small animal carrier with wheel assembly 40 on its bottom side 30. Tray 80 may be supported on top of support pads 50 and may include cushion 82. Handles 72 and 74 may be connected to bottom side 30 by way of detachable strap 76. Strap 122 for pulling the carrier may be attached to ring 120.

Whatever the precise merits, features, and advantages of the above cited references, none of them achieves or fulfills the purposes of the present invention.

### SUMMARY OF THE INVENTION

The present invention provides for a carrier comprising: (a) a pet carrier portion comprising a carrier top portion having a first set of retaining mechanisms, a carrier bottom portion formed by a slidable heavy fine gauge metal screen that locks into place to support a pet resident within the carrier, a carrier anterior portion and a carrier posterior portion, each having a set of ventilation openings distributed in a predetermined pattern thereon, and said carrier anterior portion having a second set of retaining mechanisms, a carrier front portion comprising an entry door having a plurality of openings covered with a see-through material and comprising a third set of retaining mechanisms, said third set of retaining mechanisms engaging said first set of retaining mechanisms on said carrier top portion to close said entry door, a carrier back portion, and (b) a litter box portion located below said pet carrier portion comprising: a litter box anterior portion, said litter box anterior portion having a handle and having a fourth set of retaining mechanisms, said fourth set of retaining mechanisms engaging said second set of retaining mechanisms to lock said pet carrier portion and said litter box portion together; a litter box posterior portion; a litter box front portion; a litter box back portion; and a litter box bottom portion to house pet litter on one side and having a set of wheels mounted on another side, wherein the litter box portion is detachable from said pet carrier portion via disengaging said second and fourth set of retaining mechanisms.

The present invention also provides for a carrier comprising: (a) a pet carrier portion comprising: a carrier top portion having a handle, a first set of retaining mechanisms and a retractable shoulder strap; a carrier bottom portion formed by a slidable heavy fine gauge metal screen that locks into place to support a pet resident within the carrier; a carrier anterior portion and a carrier posterior portion, each having a set of ventilation openings distributed in a predetermined pattern thereon, said carrier anterior portion having a second set of retaining mechanisms; a carrier front portion comprising an entry door having a plurality of openings covered with a see-through material and comprising a third set of retaining mechanisms, said third set of retaining mechanism engaging said first set of retaining mechanisms on said carrier top portion to close said entry door; a carrier back portion containing an accessory pocket; and (b) a litter box portion located below said pet carrier portion comprising: a litter box anterior portion oriented in the same direction as said carrier anterior portion, said litter box anterior portion having a retractable and pivoting handle and having a fourth set of retaining mechanisms, said fourth set of retaining mechanisms engaging said second set of retaining mechanisms to lock said pet carrier portion and said litter box portion together; a litter box posterior portion oriented in the same direction as said carrier posterior portion; a litter box front portion oriented in the same direction as said carrier front portion; a litter box back portion oriented in the same direction as said carrier back portion; and a litter box bottom portion to house pet litter on one side and having a set of wheels on another side, said litter box bottom portion oriented in the same direction as said carrier bottom portion, wherein the litter box portion is detachable from said pet carrier portion via disengaging said second and fourth set of retaining mechanisms.

### BRIEF DESCRIPTION OF THE DRAWINGS

FIG. 1 illustrates a wheeled pet carrier with detachable litter box according to one embodiment of the present invention.

FIG. 2 illustrates the detachment of the pet carrier portion from the litter box portion shown in FIG. 1.

FIG. 3 illustrates the slidable heavy fine gauge metal screen that can be removed using the handle provided thereon.

FIG. 4 illustrates a rear view of the wheeled pet carrier with detachable litter box according to one embodiment of the present invention

FIG. 5a illustrates the wheeled pet carrier with detachable litter box with the door open showing the heavy fine gauge metal screen.

FIG. 5b illustrates another embodiment of the present invention that places a layer of a soft comfort pad on top of the heavy fine gauge metal screen.

FIG. 6 illustrates a top view of the present invention's wheeled pet carrier with detachable litter box.

FIG. 7 illustrates the heavy fine gauge metal screen with a handle.

FIG. 8 illustrates a view of the litter box portion of the present invention with the handle fully extended.

FIG. 9 illustrates a view of the litter box portion of the present invention with the handle pushed in.

### DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

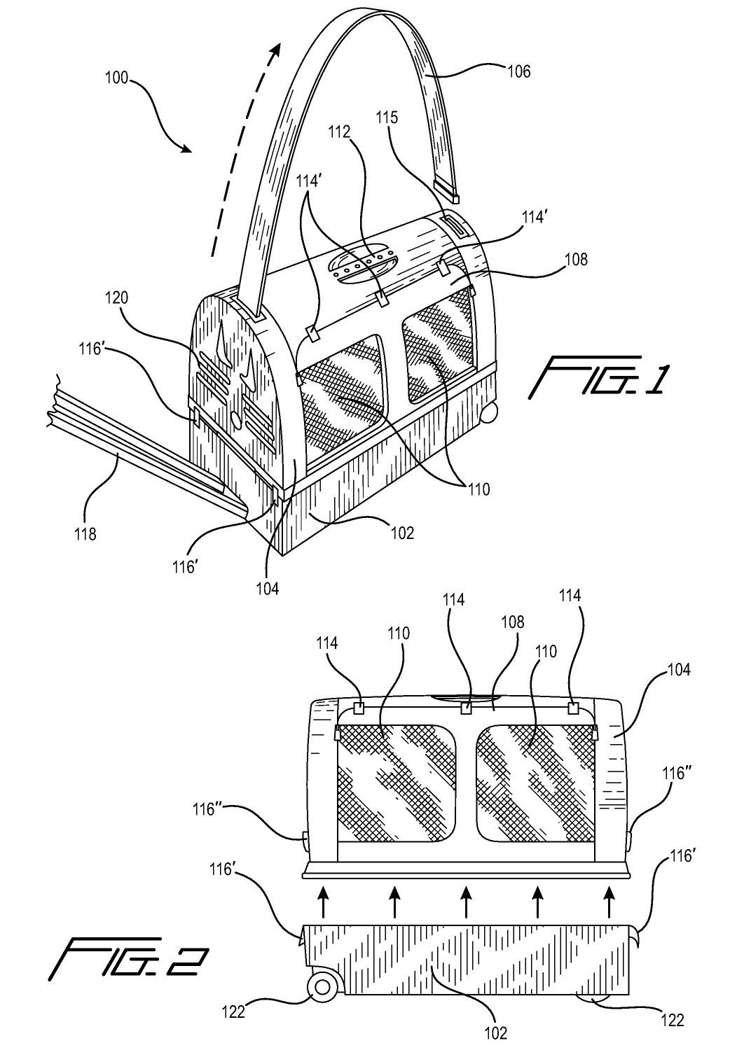

FIG. 1 illustrates one embodiment of the present invention's pet carrier with detachable litter box 100. In this embodiment, the pet carrier with detachable litter box 100 comprises a pet carrier portion 104 and a litter box portion 102.

According to this embodiment, the pet carrier portion 104 comprises a carrier top portion, a carrier bottom portion, a carrier anterior portion, a carrier posterior portion, a carrier front portion and a carrier back portion.

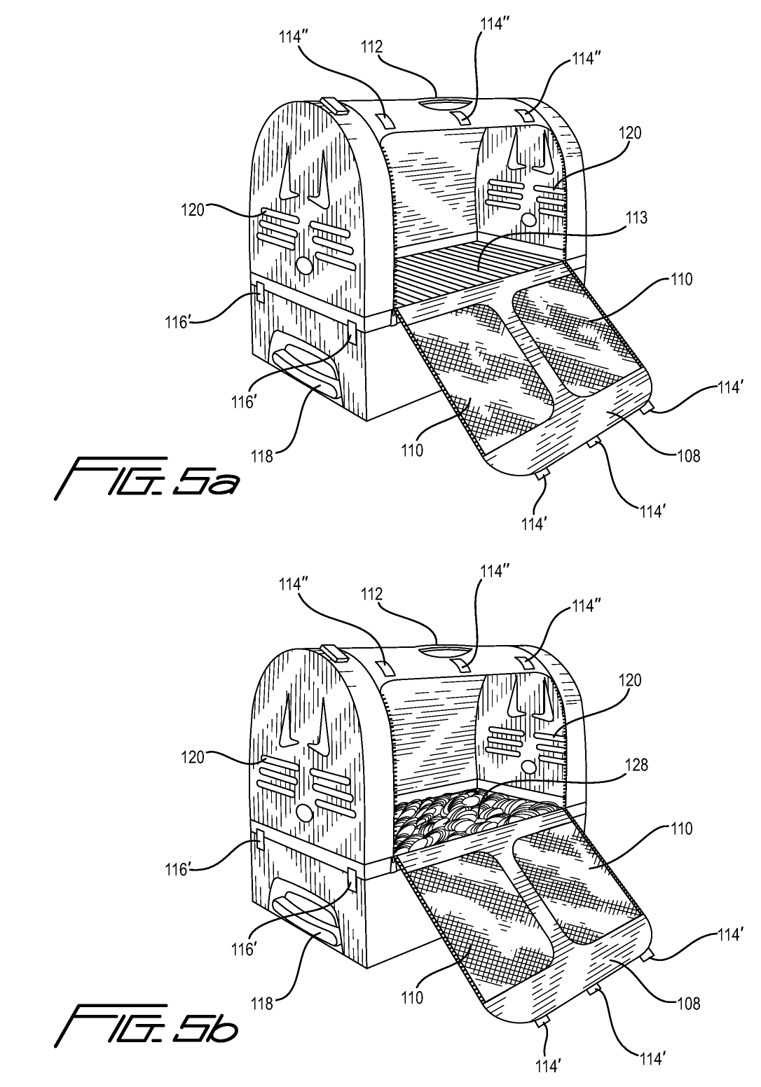

The carrier top portion has a handle 112, a first set of retaining mechanisms (not visible in FIG. 1; see FIG. 5a, a first set of retaining mechanisms 114″), and a retractable shoulder strap 106.

The carrier bottom portion is formed by a slidable heavy fine gauge metal screen (see FIG. 5a, heavy fine gauge metal screen 113) that locks into place to support a pet resident within said carrier. The heavy fine gauge metal screen 113 is strong enough to support the weight of a pet that would reside within the carrier of the present invention.

The carrier anterior portion and a carrier posterior portion, each have a set of ventilation openings 120 distributed in a predetermined pattern thereon (which can be any design pattern), wherein the carrier anterior portion has a second set of retaining mechanisms (not visible in FIG. 1; see FIG. 2, a second set of retaining mechanisms 116″).

The carrier front portion comprises an entry door 108 having a plurality of openings 110 covered with a see-through material (e.g., a mesh material, a net material, a plastic material having a plurality of openings, or a cloth material with a plurality of openings). The carrier front portion also has a third set of retaining mechanisms 114′, wherein the third set of retaining mechanism 114′ engage the first set of retaining mechanisms (not visible in FIG. 1; see FIG. 5a, a first set of retaining mechanisms 114″) on the carrier top portion to close the entry door 108.

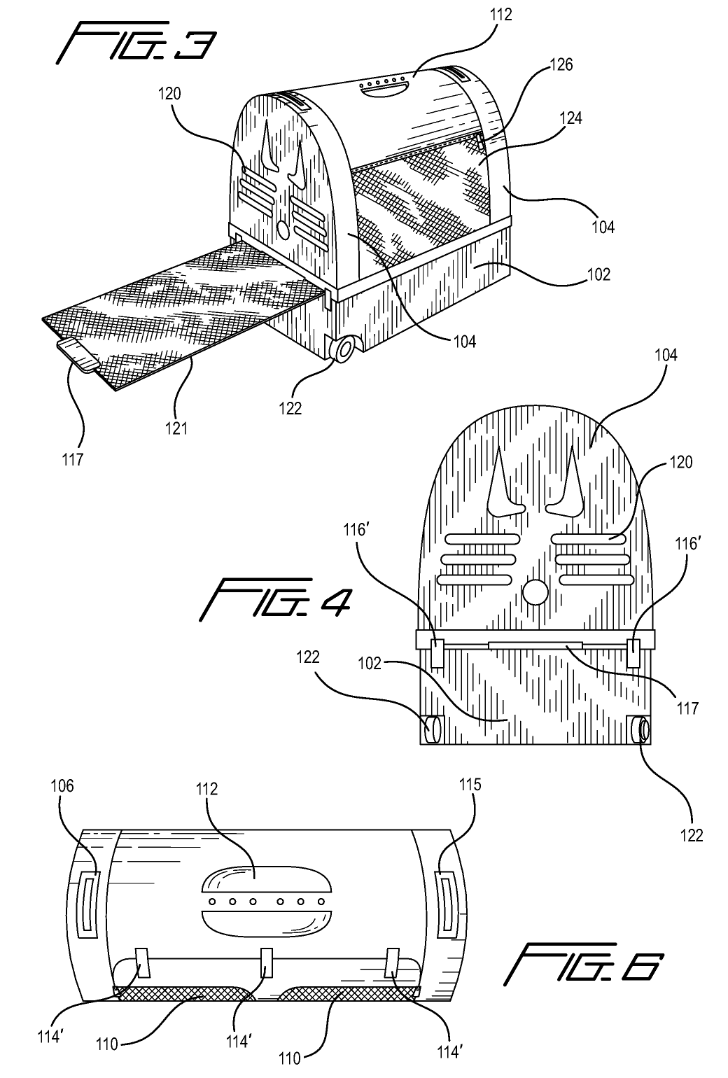

In an extended embodiment, the carrier back portion contains an accessory pocket 124 as shown in FIG. 3. The zipper pocket of FIG. 3 can be operated using a mechanism such as zipper 126 or Velcro™ (hook and loop closure mechanism).

In one embodiment, the accessory pocket 124 contains collapsible food and water bowls.

According to this embodiment, the litter box portion 102 comprises a litter box anterior portion, a litter box posterior portion (oriented in the same direction as the carrier posterior portion), a litter box front portion, a litter box back portion (oriented in the same direction as the carrier back portion), and a litter box bottom portion (oriented in the same direction as the carrier bottom portion).

The litter box anterior portion is oriented in the same direction as the carrier anterior portion, and the litter box anterior portion has a retractable and pivoting handle 118. The litter box anterior portion also has a fourth set of retaining mechanisms 116′, wherein the fourth set of retaining mechanisms 116′ engage the second set of retaining mechanisms (not visible in FIG. 1; see FIG. 2, a second set of retaining mechanisms 116″) to lock the pet carrier portion and the litter box portion together.

The litter box bottom portion houses the pet litter on one side and has a set of wheels 122 on another side.

In one embodiment, the set of wheels 122 are detachable from the carrier.

FIG. 2 illustrates the detachment of the litter box portion 102 from the pet carrier portion 104. The litter box portion 102 is detachable from the pet carrier portion 104 by disengaging the second and fourth set of retaining mechanisms (i.e., 116″ and 116′, respectively).

In one embodiment, the carrier front portion also has a zipper mechanism to close the entry door 108.

In another embodiment, the litter box portion further contains a deodorizer.

FIGS. 3 and 4 illustrate an embodiment, wherein the heavy fine gauge metal screen 113 is removable via a handle 117 that protrudes externally, and allows for the replacement of the heavy fine gauge metal screen 113 without detachment of the litter box portion 102 from the pet carrier portion 104.

FIG. 5a illustrates the inside of the carrier having the heavy fine gauge metal screen 113 that supports the pet within the carrier. FIG. 5b illustrates another embodiment, wherein a comfort pad 128 is placed over the heavy fine gauge metal screen 113. The heavy fine gauge metal screen 113 can be removed (using handle 117) to allow for a pet resident within the pet carrier portion 104 to access and use the litter box portion 102 of the carrier.

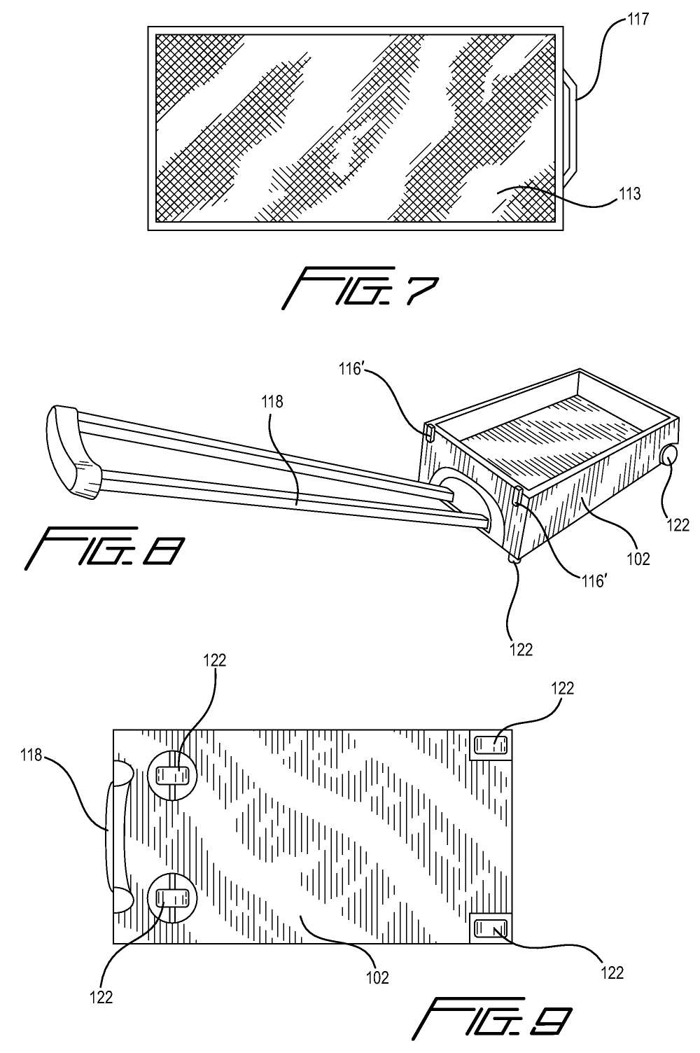

FIG. 6 illustrates a top view of the carrier of the present invention. FIG. 7 illustrates a view of the heavy fine gauge metal screen 113 with handle 117. FIG. 8 illustrates another view of the litter box portion 102 of the present invention's wheeled pet carrier showing handled 118 in a fully extended position. FIG. 9 illustrates a bottom view of the litter box portion 102 of the present invention's wheeled pet carrier, wherein the litter box portion has a set of wheels 122 (which can be detached in one embodiment) and a handle 118 that can be pulled (but is shown pushed in).

### CONCLUSION

The above embodiments show a carrier for the effective implementation of a wheeled pet carrier with a detachable litter box. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by size, materials, or specific manufacturing techniques.

1. A carrier comprising:
a. a pet carrier portion, said pet carrier portion comprising
(i). a carrier top portion having a first set of retaining mechanisms;
(ii). a carrier bottom portion formed by a slidable heavy fine gauge metal screen that locks into place to support a pet resident within said carrier;
(iii). a carrier anterior portion and a carrier posterior portion, each having a set of ventilation openings distributed in a predetermined pattern thereon, and said carrier anterior portion having a second set of retaining mechanisms;
(iv). a carrier front portion comprising an entry door having a plurality of openings covered with a see-through material and comprising a third set of retaining mechanisms, said third set of retaining mechanisms engaging said first set of retaining mechanisms on said carrier top portion to close said entry door;
(v). a carrier back portion;
b. a litter box portion located below said pet carrier portion comprising:
(i). a litter box anterior portion oriented in the same direction as said carrier anterior portion, said litter box anterior portion having a handle and having a fourth set of retaining mechanisms, said fourth set of retaining mechanisms engaging said second set of retaining mechanisms to lock said pet carrier portion and said litter box portion together;
(ii). a litter box posterior portion oriented in the same direction as said carrier posterior portion;
(iii). a litter box front portion oriented in the same direction as said carrier front portion;
(iv). a litter box back portion oriented in the same direction as said carrier back portion; and
(v). a litter box bottom portion to house pet litter on one side and having a set of wheels mounted on another side, said litter box bottom portion oriented in the same direction as said carrier bottom portion,
said litter box portion detachable from said pet carrier portion via disengaging said second and fourth set of retaining mechanisms.

2. The carrier of claim 1, wherein said carrier top portion additionally comprises a retractable shoulder strap.

3. The carrier of claim 1, wherein said carrier back portion additionally comprises an accessory pocket.

4. The carrier of claim 3, wherein said accessory pocket stores at least one collapsible food bowl and/or at least one water bowl.

5. The carrier of claim 1, wherein said handle is a retractable and pivoting handle.

6. The carrier of claim 1, wherein in addition to said third set of retaining mechanisms engaging said first set of retaining mechanisms, said carrier front portion having a zipper or hook and loop closure mechanism to close said entry door.

7. The carrier of claim 1, wherein said litter box portion further contains a deodorizer.

8. The carrier of claim 1, wherein a comfort pad is placed over said heavy fine gauge metal screen.

9. The carrier of claim 1, wherein said slidable heavy fine gauge metal screen is removable via a handle that protrudes external to said carrier, allowing replacement of said slidable heavy fine gauge metal screen without detachment of said litter box portion from said pet carrier portion.

10. The carrier of claim 1, wherein said see-through material is any of the following:
a mesh material, a net material, a plastic material having a plurality of openings, or a cloth material with a plurality of openings.

11. The carrier of claim 1, wherein said set of wheels are detachable from said carrier.

12. A carrier comprising:
a. a pet carrier portion, said pet carrier portion comprising
(i). a carrier top portion having a handle, a first set of retaining mechanisms and a retractable shoulder strap;
(ii). a carrier bottom portion formed by a slidable heavy fine gauge metal screen that locks into place to support a pet resident within said carrier;
(iii). a carrier anterior portion and a carrier posterior portion, each having a set of ventilation openings distributed in a predetermined pattern thereon, said carrier anterior portion having a second set of retaining mechanisms;
(iv). a carrier front portion comprising an entry door having a plurality of openings covered with a see-through material and comprising a third set of retaining mechanisms, said third set of retaining mechanisms engaging said first set of retaining mechanisms on said carrier top portion to close said entry door;
(v). a carrier back portion containing an accessory pocket;
b. a litter box portion located below said pet carrier portion comprising:
(i). a litter box anterior portion oriented in the same direction as said carrier anterior portion, said litter box anterior portion having a retractable and pivoting handle and having a fourth set of retaining mechanisms, said fourth set of retaining mechanisms engaging said second set of retaining mechanisms to lock said pet carrier portion and said litter box portion together;
(ii). a litter box posterior portion oriented in the same direction as said carrier posterior portion;
(iii). a litter box front portion oriented in the same direction as said carrier front portion;
(iv). a litter box back portion oriented in the same direction as said carrier back portion; and
(v). a litter box bottom portion to house pet litter on one side and having a set of wheels on another side, said litter box bottom portion oriented in the same direction as said carrier bottom portion,
said litter box portion detachable from said pet carrier portion via disengaging said second and fourth set of retaining mechanisms.

13. The carrier of claim 12, wherein in addition to said third set of retaining mechanisms engaging said first set of retaining mechanisms, said carrier front portion having a zipper or hook and loop closure mechanism to close said entry door.

14. The carrier of claim 12, wherein said litter box portion further contains a deodorizer.

15. The carrier of claim 12, wherein a comfort pad is placed over said heavy fine gauge metal screen.

16. The carrier of claim 12, wherein said slidable heavy fine gauge metal screen is removable via a handle that protrudes external to said carrier, allowing replacement of said slidable heavy fine gauge metal screen without detachment of said litter box portion from said pet carrier portion.

17. The carrier of claim 12, wherein said see through material is any of the following:
a mesh material, a net material, a plastic material having a plurality of openings, or a cloth material with a plurality of openings.

18. The carrier of claim 12, wherein said accessory pocket stores at least one collapsible food bowl and/or at least one water bowl.

19. The carrier of claim 12, wherein said set of wheels are detachable from said carrier.
